(19) United States
(12) Patent Application Publication
(10) Pub. No.: US 2022/0379811 A1
(43) Pub. Date: Dec. 1, 2022

(54) STOWING DEVICE, CAB, AND WORKING MACHINE

(71) Applicant: Caterpillar SARL, Geneva (CH)

(72) Inventors: Rie ADACHI, Akashi-shi (JP); Eiji AKAHANE, Akashi-shi (JP)

(73) Assignee: Caterpillar SARL, Geneva (CH)

(21) Appl. No.: 17/829,448

(22) Filed: Jun. 1, 2022

(30) Foreign Application Priority Data
Jun. 1, 2021 (JP) 2021-092217

(51) Int. Cl. B60R 7/04; E02F 9/16; B62D 33/063; B62D 25/20; B62D 33/06

(52) U.S. Cl. CPC B60R 7/04; E02F 9/163; B62D 33/0636; B62D 25/20; B62D 33/0617; A01G 23/00

(57) ABSTRACT

To provide a stowing device, cab, and working machine, that may hardly make an operation cabin dirty by something stored such as outdoor shoes and prevent something stored from being made dirty or lost. A stowing device is disposed accessibly from behind an operator's seat in an operation cabin on an inside of a cab comprising an entrance at a back part and comprises a stowing part capable of storing something. As it is possible to store outdoor shoes in the stowing part (40) and change into indoor shoes when getting on the operation cabin through the entrance, the operation cabin will be hardly made dirty by the dust attached on the outdoor shoes and others. As something such as outdoor shoes may be stored in the cab, something stored will not get dirty in the rainy weather and be prevented from being lost during work.

### FIELD OF THE INVENTION

The present invention relates to a stowing device capable of stowing outdoor shoes of an operator, for example, a cab having the device, and a working machine comprising the device.

### BACKGROUND OF THE INVENTION

Conventionally, forestry working machines with a cab riser specification have been provided where an operation cabin is disposed at a high position in order to improve view. The forestry working machine with the cab riser specification may move timber or load a carrier with timber by operating a working arm from a position overlooking the timber. A transparent member such as glass may be used under an operator's seat of the floor part of the cab in order to make it easy to overlook the field from high position during these tasks.

When the operator gets on the cab with outdoor shoes on to which dust such as mud is attached, the floor part gets dirty by the dust on a sole of the outdoor shoes, so that visibility through the transparent floor part will become worse. Therefore, the operator may take off the outdoor shoes or change into indoor shoes when getting in the operation cabin.

When the outdoor shoes taken off are left outside the cab, they may drop to be lost during work. Therefore, a working machine is known which comprises a stowing device for storing outdoor shoes outside the cab such as on a lower front part of the cab (see PTLs 1, 2, for example).

However, when storing something including outdoor shoes in the stowing device disposed outside the cab, there is a concern that it might get wet in the rainy weather or drop during work, for example.

A working machine is known which comprises the stowing device inside the cab such as on a right front side or on a lower to left lateral side of the operator's seat (see PTLs 3, 4, for example).

However, when the stowing device is on the right front of the operator's seat, for example, the stowing device or something stored in the device such as outdoor shoes might hinder the sight of the transparent floor part in front of the operator's seat. Also, the operator will move with outdoor shoes on attached with the dust and so on before sitting in the operator's seat, so that the floor part of the cab might get dirty inevitably.

When the stowing device is on the lower to left lateral side of the operator's seat, for example, and when the cab is of side door type which has a door on a left lateral side of the operator's seat, it is not easy to afford enough space in the operation cabin for the operator to put on or take off the outdoor shoes. Whereas, when the cab is of rear entry type where the operator gets in the operation cabin from the back part of the cab through the door behind the operator's seat, there may be enough space. However, when the stowing device is on the lower to left lateral side of the operator's seat, for example, the operator may not store the outdoor shoes taken off immediately.

### PRIOR ART DOCUMENTS

### Patent Documents

PTL 1: Japanese Unexamined Patent Application Publication No. 2015-105476
PTL 2: Japanese Unexamined Patent Application Publication No. 2015-105477
PTL 3: Japanese Unexamined Patent Application Publication No. 2012-46887
PTL 4: Japanese Unexamined Patent Application Publication No. H8-92999

### SUMMARY OF THE INVENTION

### Problem to be Solved by the Invention

As explained above, the stowing device is required which may hardly make the operation cabin dirty by outdoor shoes, etc., and prevent something dirty from being lost.

This invention is conceived to address the problem, and is intended to provide the stowing device so that the operation cabin may hardly be made dirty by something stored such as outdoor shoes, and prevent something stored from being made dirty or lost, and to provide a cab having the device and working machine comprising the device.

### Means for Solving the Problem

The invention defined in claim 1 provides a stowing device being disposed accessibly from behind an operator's seat in an operation cabin on an inside of a cab comprising an entrance at a back part and comprising a stowing part capable of storing something.

The invention defined in claim 2 provides the stowing device, wherein the stowing part in the stowing device defined in claim 1 is disposed removably relative to the cab.

The invention defined in claim 3 provides the stowing device, wherein at least a part of the stowing part in the stowing device defined in claim 1 or 2 is slanted downwards toward the back in a disposed state.

The invention defined in claim 4 provides the stowing device, wherein the stowing part in the stowing device defined in any of claims 1 to 3 is formed with an opening at a top part.

The invention defined in claim 5 provides a cab comprising an operation cabin, an entrance formed behind in communication with the operation cabin, an operator's seat disposed in the operation cabin, and the stowing device defined in any of claims 1 to 4 and disposed behind the operator's seat in the operation cabin.

The invention defined in claim 6 is a working machine comprising a body, and the cab defined in claim 5 and mounted on this body.

The invention defined in claim 7 is the working machine, wherein the cab in the working machine defined in claim 6 is disposed vertically movably relative to the body.

The invention defined in claim 8 is the working machine, wherein the cab in the working machine defined in claim 7 comprises a visible part allowing to view outside on the floor part at least in front of the operator's seat.

### FAVORABLE EFFECTS OF THE INVENTION

According to the embodiment of this invention of claim 1, as it is possible to store outdoor shoes in the stowing part or change into indoor shoes when getting on the operation cabin through the entrance, the operation cabin will be hardly made dirty by something stored such as dust attached on the outdoor shoes and something such as outdoor shoes may be stored in the cab, so that something stored will not get dirty in the rainy weather and be prevented from being lost during work.

According to the embodiment of this invention of claim 2, even if the stowing part gets dirty, the stowing part may be removed to be cleaned or washed easily.

According to the embodiment of this invention of claim 3, something stored may be easily taken in and out from rear of the stowing part.

According to the embodiment of this invention of claim 4, the stowing device may be easy to store something and be easily used as stowing space for something small.

According to the embodiment of this invention of claim 5, the operation cabin may be hardly made dirty by the outdoor shoes, etc., and something stored in the stowing device may be prevented from being made dirty and lost.

According to the embodiment of this invention of claim 6, the operation cabin may be hardly made dirty and the operator can work while storing something including outdoor shoes in a stable manner, so that the working machine may provide favorable operability.

According to the embodiment of this invention of claim 7, the operator can work from a position overlooking the timber in the working machine used in forestry, providing good operability.

According to the embodiment of this invention of claim 8, the operator can easily overlook a field through the visible part from higher position and the stowing device may prevent the operation cabin from being made dirty by the dust attached on a sole of the outdoor shoes, so that visibility through the visible part may be hardly degraded by the dust.

### BRIEF DESCRIPTION OF THE DRAWINGS

FIG. 1 is a plane view of the operation cabin illustrating the embodiment of the cab having the stowing device according to the present invention.

FIG. 2(a) is a plane view of the stowing device above, (b) is a side view of the stowing device, (c) is a perspective view of the stowing part seen from above of the stowing device, (d) is the perspective view of the stowing part seen from bottom, and (e) is the plane view illustrating a support part of the stowing device.

FIG. 3 is the perspective view illustrating an example of the working machine comprising the cab above.

### DETAILED DESCRIPTION OF THE INVENTION

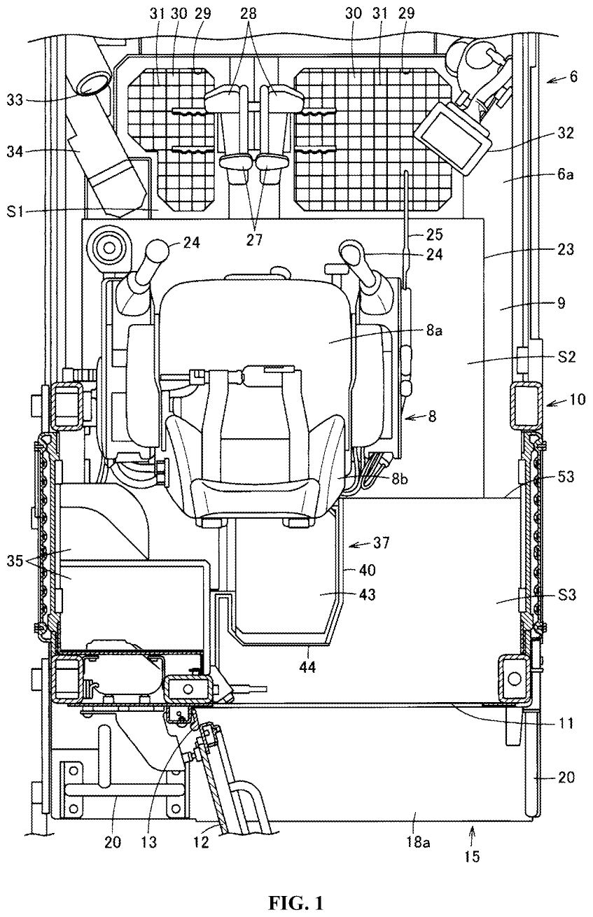

Now, an explanation will be provided in detail about this invention based on an embodiment shown in FIGS. 1 to 3.

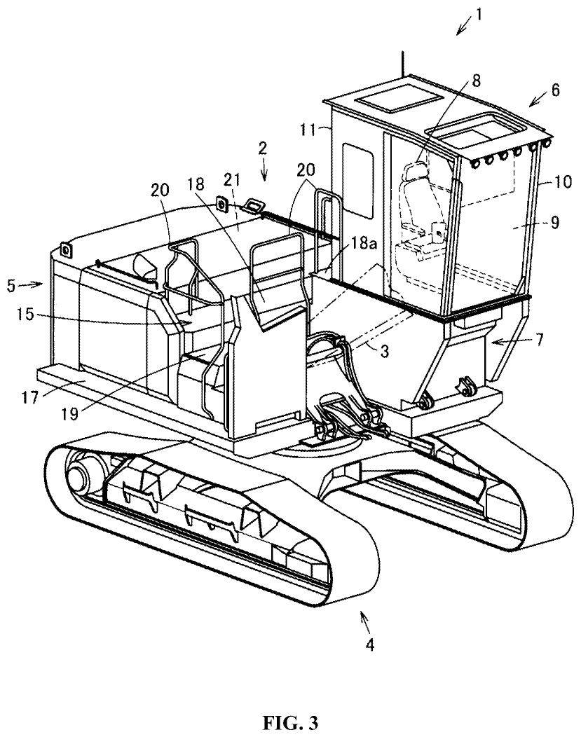

FIG. 3 illustrates a working machine 1. The working machine 1 is forestry working machine referred to as a forest machine and others. In this embodiment, the explanation is provided by referring to a hydraulic excavator based machine as an example of the working machine 1. In the example illustrated, the working machine 1 comprises a body 2, and a work device 3, which is a working arm movably provided to the body 2. Each part of the working machine 1 is driven by a hydraulic actuator. The hydraulic actuator is a hydraulic cylinder and hydraulic motor, for example, and each motion becomes possible by supplying/discharging hydraulic oil, which is working fluid delivered from a pump driven an engine mounted in the body 2, whose flow rate and direction are controlled by a control valve according to an operator's operation.

In the present embodiment, the body 2 has a lower traveling body 4 movable with crawler track, tire, etc., and an upper swiveling body 5 swivelably provided on the lower traveling body 4. The upper swiveling body 5 is mounted with a work device 3 and a cab 6. In the present embodiment, the cab 6 has a cab riser specification which enables the cab 6 to move vertically relative to the body 2. For example, the cab 6 is moved vertically relative to the body 2 by the cab riser 7, which is a hydraulically driven cab elevating means operable by a hydraulic cylinder, etc. Note that, longitudinal, horizontal, and vertical directions are based on the direction seen from the operator when the operator sits down on the operator's seat 8 in the cab 6.

The cab 6 shown in FIGS. 1 and 3 is located on the left side of the work device 3. The cab 6 is formed in a box shape and surrounds the operation cabin 9, where the operator's seat 8 is installed. In the example illustrated, the cab 6 is formed in the box shape having almost six planes: front face part, left and right side parts, rear face part, ceiling part as an upper face part, and floor part as a lower face part. The cab 6 has a cab frame 10 comprised of a pillar, a beam, a panel, and others. The cab frame 10 is provided with a window part in order to ensure the operator's view. In the present embodiment, the window part is provided on the front face part, left and right side parts, ceiling part, and floor part, respectively, of the cab frame 10. The window part is covered with a transparent visible member such as glass or resin, and the visible member may be opened/closed, as required.

Also, the cab frame 10 is provided with an entrance 11 in communication with the operation cabin 9, which enables the operator to enter into and exit from the operation cabin 9. In the present embodiment, the entrance 11 is provided on the rear face part of the cab frame 10. That is, the cab 6 according to the present embodiment is a rear entry type. The entrance 11 may be opened/closed by the door 12. The door 12 is rotatably or slidably attached to the cab frame 10. In the example illustrated, the door 12 is rotatably attached through the hinge 13 to the cab frame 10 so that the door will open outward from the operation cabin 9.

A passage 15 facing to the entrance 11 and door 12 is provided, for the operator to get on the cab 6. The passage 15 is provided on the upper swiveling body 5. In the present embodiment, the passage 15 is formed extending from a lateral side of the body 2 over the back part of the cab 6 in a horizontal direction, i.e., a width direction of the cab. In the example illustrated, the passage 15 is formed with a stepwise step 19 from an end of a catwalk 17, which is a scaffold part formed at both lateral sides of the upper swiveling body 5, over a platform 18 disposed and formed on the upper swiveling body 5 at a back part of the cab 6, and is installed with a handrail 20, where appropriate, which is an elevation assisting means.

The catwalk 17 is formed in a longitudinal direction. The platform 18 is formed extending in a horizontal direction in front of an engine room 21. These catwalk 17 and platform 18 are available for maintaining each part such as the engine in the engine room 21.

Next, the explanation is provided about internal structure of the cab 6.

The operator's seat 8 in the cab 6 has a seat part 8a for the operator to sit on and a backrest part 8b standing up from the seat part 8a. Preferably, an angle of front/rear inclination of the backrest part 8b is adjustable, i.e., reclinable, relative to the seat part 8a.

In the cab 6, the operator's seat 8 is installed on the floor part 6a. As for the cab 6 as shown in the present embodiment, where the cab riser 7 enables the cab to move vertically, the cab 6 is firmly (rigidly) secured to the cab riser 7 without using a damping member in order to suppress a vibration of the cab 6. Therefore, in the cab 6, the operator's seat 8 is installed on the floor part 6a through the damping member to suppress the vibration of the operator's seat 8, and the seat is spaced away from the floor part 6a and wall part. In the present embodiment, the floor part 6a is covered with a mat 23 from both lateral sides to a front part of the operator's seat 8. The mat 23 is basically a mat for indoor shoes where the operator walks with indoor shoes on basically. The mat 23 is disposed integrally with the operator's seat 8.

On both lateral sides of the operator's seat 8, a lever 24 is laid out which is an operation body for the operator to operate swiveling of the work device 3 and upper swiveling body 5. Also, further to the right of the right lever 24 of the operator's seat 8, a lock lever 25 is disposed to switch between lock and unlock of hydraulic circuit.

Also, according to the present embodiment, in the cab 6, the operator's seat 8 is positioned shifted by one side to left side opposite to the work device 3. So, in the operation cabin 9, there are spaces S1 to S3 respectively in front of the operator's seat 8 and at a right lateral side and rear side as other lateral sides.

In the front space S1 of the operator's seat, the lever 27 and pedal 28, which are travel operation part for the operator to operate travel of lower traveling body 4, are disposed on the floor part 6a in front of the operator's seat 8. In the present embodiment, in the front space S1 of the operator's seat 8, each window part 29, which is a transparent visible part allowing to view outside, is formed on the floor part 6a at both lateral sides of the lever 27 and pedal 28. The window part 29 allows the operator to look downward when the cab 6 is moved up. In the example illustrated, the window part 29 is covered by transparent visible member 30 such as glass and resin, and the transparent visible member 30 is covered by a latticed guard member 31. Further, in the present embodiment, in the front space S1 of the operator's seat 8, a monitor 32 having functions of display and setting means and a blowoff opening 33 of air conditioner are disposed above and apart from the floor part 6a on the left and right in front of the cab 6. The blowoff opening 33 is in communication with a first air conditioner body disposed below the floor of the cab 6 through a duct disposed along the floor part 6a and the pillar of the cab frame 10. The duct is protected by a protective cover 34. The protective cover 34 is made of metal sheet, for example.

The space S2 on a right lateral side of the operator's seat 8, is a movable space between the operator's seat 8 and entrance 11 for the operator. Since the lock lever 25 is located at an unlock position between the space S2 and operator's seat 8, when the operator gets on the operator's seat 8 from the space S2, it is needed to change the lock lever 25 over to a lock position.

A space S3 behind the operator's seat 8 is located between the operator's seat 8 and entrance 11 and faces to the door 12. Devices such as second air conditioner body and electric component is disposed on the floor part 6a in the space S3 behind the operator's seat 8 and its top part is covered with a cover 35. The air conditioner body is a maintenance needed device which may require a maintenance such as a filter changeover, and the electric component is the maintenance needed device which may require the maintenance such as a part changeover. In the present embodiment, the maintenance needed device and its cover 35 are disposed at a left rear side of the operator's seat 8. The maintenance needed device and its cover 35 are disposed in front of the hinge 13 of the door 12, so that they will not hinder the operator from entering into and exit from the entrance 11.

Moreover, the stowing device 37 is disposed in the space S3 behind the operator's seat 8. The stowing device 37 is disposed accessibly from behind the operator's seat 8. In the present embodiment, the stowing device 37 is disposed just behind the operator's seat 8. The stowing device 37 functions as a shoe box for the operator to store outdoor shoes. The stowing device 37 is disposed facing to the entrance 11. The stowing device 37 is located next to the right lateral side of the maintenance needed device and cover 35 and does not hinder the operator from moving from one to another among the entrance 11, space S3, and right lateral side space S2.

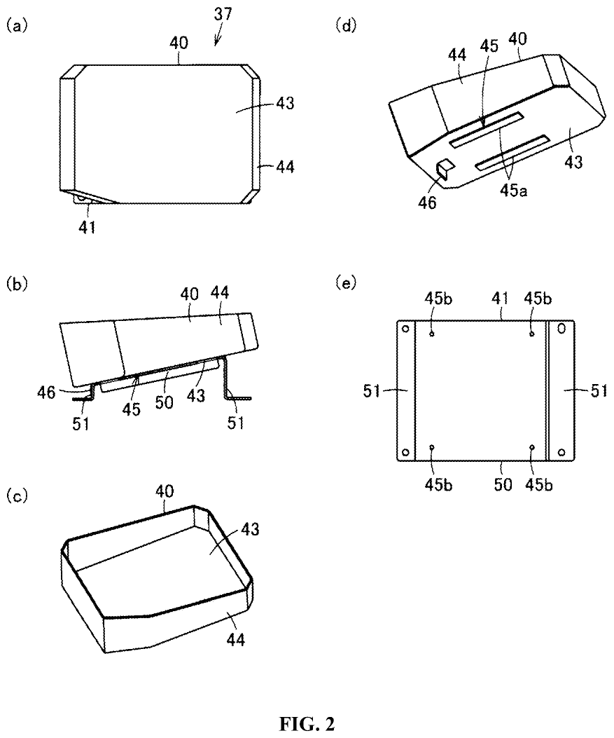

As shown in FIG. 1 and FIGS. 2(a) to 2(e), in the present embodiment, the stowing device 37 has a stowing part 40 capable of storing and holding something and support part 41 as a groundsill part supporting the stowing part 40.

The stowing part 40 is formed in a tray shape with upper opening. In the example illustrated, the stowing part 40 integrally has a bottom part 43, sidewall part 44 standing from around the bottom part 43. In the present embodiment, the bottom part 43 is formed roughly in a square shape and four corners are C chamfered. The stowing part 40 is disposed removably relative to the cab 6. The stowing part 40 may be easily and removably fixed to the cab 6 using removable fixing means 45 such as a magnet and hook-and-loop fastener. That is, the stowing part 40 is removable by the operator's hand without using a tool. In the present embodiment, the stowing part 40 is disposed removably relative to the top part of a support part 41 fixed to the cab 6. That is, first fixing means 45a is attached to a lower part of the bottom part 43 of the stowing part 40 and the first fixing means 45a is adsorbed to the top part of the support part 41, so the stowing part 40 will be fixed removably relative to the support part 41. That is, in the present embodiment, the top part of the support part 41 is second fixing means for receiving first fixing means 45a. In the example illustrated, a pair of first fixing means 45a are disposed on left and right of the bottom part 43 and extend linearly in a longitudinal direction. To fix the stowing part 40 to the support part 41 firmly or install another stowing part, a nut 45a, which is a fixing member to enable to fix a bolt, may be disposed on a top of the support part 41.

Also, at least a part of the stowing part 40 is slanted downwards toward the back in a disposed state. In the present embodiment, the stowing part 40 is slanted downwards toward the back as a whole in a disposed state. The flat bottom part 43 of the stowing part 40 is disposed being slanted downwards toward the back so that a normal direction of the bottom part 43 will orient backwards and upwards. In the example illustrated, the support part 41 is slanted and the bottom part 43 of the stowing part 40 is placed on the support part 41, so the bottom part 43 of the stowing part 40 is slanted. Regardless of this, the stowing part 40 itself may be slanted so that the stowing part may have a structure supported by the horizontal support part 41. In the present embodiment, the stowing part 40 is formed so that upper end part of the sidewall part 44 will be almost horizontal in a disposed state.

In the example illustrated, a restriction part 46, which regulates a front/back position of the stowing part 40 relative to the support part 41, is attached to the stowing part 40. The restriction part 46 is formed of an L shape and is disposed at front or back part of the lower part of the bottom part 43. For example, in the present embodiment, the restriction part 46 is disposed close to the back part of the bottom part 43.

The support part 41 is fixed to the floor part 6a of the cab 6. In the present embodiment, the support part 41 integrally has a support part body 50 receiving the stowing part 40 and a fixed part 51 fixing the support part body 50 to the floor part 6a of the cab 6. The support part body 50 is formed in a flat plate shape. The support part body 50 has a width not more than the bottom part 43 of the stowing part 40, and preferably has the width not less than half of the bottom part 43. Second fixing means 45b is disposed on the top part of the support part body 50.

The fixed part 51 is disposed extending downwards from the support part body 50, and its distal part is bent along the floor part 6a and is fixed on the floor part 6a by a fixing member such as a bolt. In the example illustrated, the fixed part 51 is integrally formed with both front/rear end parts of the support part body 50. The front fixed part 51 is formed higher than rear fixed part 51, so the support part body 50 is disposed on the cab 6 so that the support part body 50 will be slanted downwards toward the back.

In the present embodiment, the stowing device 37 is installed at the floor part 6a and is located close to the floor part 6a. That is, the stowing device 37 is positioned on a foot of the operator facing to the entrance 11. The floor part 6a is covered with the mat 53 around the stowing device 37. The mat 53 is fixed to the floor part 6a of the space S3 facing to the entrance 11. The space S3 is a space only for indoor shoes, where the operator may move with indoor shoes on after taking off the outdoor shoes, so the mat 53 is basically for indoor shoes, where the operator steps with indoor shoes on. The back part of the mat 23 is positioned overlapped with the front part of the mat 53. Therefore, the front part of the mat 53 may rub the back part of the mat 23 in an overlapped way, which vibrates integrally with the operator's seat 8 when the operator's seat 8 vibrates.

Next, the explanation will be provided on a function of the embodiment illustrated.

When the operator gets on the operation cabin 9 in the cab 6, the operator accesses to the cab 6 through the passage 15 from the lateral side of the working machine 1. That is, the operator ascends the catwalk 17, and then from the catwalk 17, ascends to the platform 18 using the step 19 and handrail 20, moves the platform 18 to open the door 12 from the back part of the cab 6 and get on the operation cabin 9. Here, in order not to soil the floor part 6a and especially the window part 29 with dust such as the mud attached to the outdoor shoes, the operator changes out of outdoor shoes into indoor shoes before and after the door 12, i.e., at the platform 18a behind the door 12, and then enters into the operation cabin 9. The outdoor shoes taken off are stored into the stowing part 40 of the stowing device 37. Similarly, something small and others, which is unnecessary for the work, may be stored in the stowing part 40 of the stowing device 37.

After changing into indoor shoes, the operator closes the door 12, goes through the space S3 and space S2, moves the lock lever 25 to the lock position, and goes around the space S1 in front of the operator's seat 8 to sit down. The operator adjusts the position of the operator's seat 8 appropriately, as required, and then starts up the engine, moves the lock lever 25 to the unlock position, operates the lever 27, pedal 28, and others to travel the working machine 1, and operates the lever 24 to perform work using the work device 3.

Thus, by installing the stowing device 37, which is disposed accessibly from behind the operator's seat 8 in the operation cabin 9 in the cab 6 comprising the entrance 11 at the back part and comprises the stowing part 40 capable of storing something, it is possible to store outdoor shoes in the stowing part 40 and change into indoor shoes when getting on the operation cabin 9 through the entrance 11, for example, so the operator will not perform work with outdoor shoes on in the operation cabin 9, the outdoor shoes will not be left untouched in the operation cabin 9 during work, the operation cabin 9 will be hardly made dirty by the dust attached on the outdoor shoes and something stored, something such as outdoor shoes may be stored in the cab 6, thus something stored will not get dirty in the rainy weather and be prevented from being lost during work.

By disposing the stowing part 40 removably relative to the cab 6, the stowing part 40 can be removed and cleaned or washed easily even when the stowing part 40 gets dirty. Also, when accessing to the maintenance needed device disposed on the lateral side of the stowing device 37 in the operation cabin 9, maintaining maintenance needed device may not be impeded by removing the stowing part 40.

As at least a part of the stowing part 40 is slanted downwards toward the back in a disposed state, something stored such as outdoor shoes may be easily taken in and out from rear of the stowing part 40, and when the backrest part 8b of the operator's seat 8 is reclined, the backrest part 8b may hardly interfere with the stowing part 40 and something stored in the stowing part 40.

As the stowing part 40 is formed in a shape with upper opening, it is easy to store something and is available for use as a stowing space for not only outdoor shoes but something small.

By installing the cab 6, the operation cabin 9 may be hardly made dirty and the operator can work while storing something including outdoor shoes in a stable manner, so that the working machine 1 may provide favorable operability.

As the cab 6 is disposed vertically movably relative to the body 2, the operator can work from a position overlooking the timber in the working machine 1 used in forestry, providing good operability.

In this case, by installing the window part 29 allowing to view outside at least on the floor part 6a in front of the operator's seat 8 in the cab 6, the operator can easily overlook the field through the window part 29, and by disposing the stowing device 37 facing to the entrance 11, the operator will take off outdoor shoes and store the outdoor shoes in the stowing part 40 of the stowing device 37 when getting on the operation cabin 9, so that the operation cabin 9 may be hardly made dirty by the dust attached on the sole of the outdoor shoes and the visibility through the window part 29 may hardly be degraded by the dust.

Note that, in the embodiment mentioned above, the stowing device 37 may be not only in a tray shape but comprising an opening/closing lid or in a drawer shape, as long as accessible from behind.

The stowing device 37 may be installed not only on the floor part 6a but on the bottom behind the operator's seat 8 and others.

The working machine 1 may be not only hydraulic excavator based but any other working machine based such as a loader and truck based.

### INDUSTRIAL APPLICABILITY

The present invention has industrial applicability for business owners who are engaged in manufacturing and sales of the stowing device installed in the cab of working machine, cab, or working machine.

1. A stowing device being disposed accessibly from behind an operator's seat in an operation cabin on an inside of a cab comprising an entrance at a back part and comprising a stowing part capable of storing something.

2. The stowing device of claim 1, wherein the stowing part is disposed removably relative to the cab.

3. The stowing device of claim 1, wherein at least a part of the stowing part is slanted downwards toward the back in a disposed state.

4. The stowing device of claim 1, wherein the stowing part is formed with an opening at a top part.

5. A cab comprising:
an operation cabin,
an entrance formed behind in communication with the operation cabin,
an operator's seat disposed in the operation cabin, and
the stowing device defined in claim 1 and disposed behind the operator's seat in the operation cabin.

6. A working machine comprising:
a body, and
the cab defined in claim 5 and mounted on the body.

7. The working machine of claim 6, wherein the cab is disposed vertically movably relative to the body.

8. The working machine of claim 7, wherein the cab comprises a visible part allowing to view outside on the floor part at least in front of the operator's seat.
